(19) United States
(12) Patent Application Publication
(10) Pub. No.: US 2009/0206257 A1
(43) Pub. Date: Aug. 20, 2009

(54) PATTERN INSPECTION METHOD AND INSPECTION APPARATUS

(75) Inventors: Yasuhiro GUNJI, Hitachiota (JP); Taku Ninomiya, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/369,369

(22) Filed: Feb. 11, 2009

(30) Foreign Application Priority Data
Feb. 14, 2008 (JP) 2008-032745

(51) Int. Cl. G01N 23/00

(52) U.S. Cl. 250/310

(57) ABSTRACT

An object of the present invention is to provide an inspection apparatus and an inspection method excellent in that high-sensitivity defect detection performance is achieved without causing throughput degradation even if an adequate contrast of a defective region cannot be obtained due to characteristics of an inspected sample. To achieve the object, according to the present invention, an SEM pattern inspection apparatus for determining defective portions from an image generated based on secondary electrons or reflected electrons generated from the sample after causing an electron beam to repeatedly scan the inspected sample reciprocatingly on a line has a function to use a retrace of the electron beam for image acquisition, precharging, or discharging.

### BACKGROUND OF THE INVENTION

1. Field of the Invention

The present invention relates to an inspection apparatus and an inspection method for inspecting semiconductor devices, substrates, photo masks (masks for exposure), liquid crystals and the like having fine patterns using a scanning electron microscope.

2. Description of the Related Art

A semiconductor device such as a memory and microcomputer used in a computer and like is manufactured by repeating a process of transferring patterns such as circuits formed on a photo mask by exposure processing, lithography processing, etching processing or the like. Quality of results of lithography processing, etching processing and other processing and presence of defects such as foreign matter generation in manufacturing processes of semiconductor devices significantly affect manufacturing yields of semiconductor devices. Therefore, in order to detect an occurrence of abnormal conditions or failures at an early stage or in advance, patterns on semiconductor wafers are inspected at the end of each manufacturing process.

To carry out a high-throughput and high-precision inspection with an increasing diameter of wafers and finer circuit patterns, it is necessary to acquire high-SN images at very high speed. Thus, the number of electrons necessary for irradiation using a large-current beam 1000 times or more (100 nA or more) that of a normal scanning election microscopy (hereinafter, denoted as an SEM) is ensured to retain a high SN ratio (Signal-to-Noise ratio). Further, high-speed and high-efficiency detection of secondary electrons and reflected electrons generated from a substrate is required.

Moreover, a low-velocity accelerated electron beam of 2 keV or less is used for irradiation so that a semiconductor substrate with a insulating film such as a resist is not affected by being charged (See, for example, Document pp. 622 and 623 of “Electron/Ion Beam Handbook (2nd Edition)” edited by the 132nd Committee of Japan Society for the Promotion of Science, The Nikkai Kogyo Shimbun ltd., 1986). However, with a large-current and low-velocity accelerated electron beam, an aberration arises due to a space charge effect, making a high-resolution observation difficult.

As a method to solve this problem, a technique of decelerating a high-velocity electron beam immediately before a sample and then irradiating the sample with a substantially low-velocity electron beam is known (See, for example, Japanese Unexamined Patent Application Publication JP02-142045A, Japanese Unexamined Patent Application Publication No. 06-139985A, or Japanese Unexamined Patent Application Publication No. 2005-175333A).

### SUMMARY OF THE INVENTION

In an inspection apparatus using an SEM described above, problems described below that an optical apparatus does not have arise.

One problem is that because each line is scanned with an electron beam in an unicursal fashion in the SEM system, one pixel is detected as a time and thus, throughput degrades when compared with an optical system in which a line can be captured at a time.

Further, with one-time electron beam irradiation with a single stroke, the contrast of an image may vary or an adequate contrast of a target region may not be obtained, depending on characteristics of wafer. In such a case, as described in Japanese Unexamined Patent Application Publication No. 2005-17533A, the dose of an electron beam is increased by irradiating the same line with an electron beam a plurality of times. According to this method, however, throughput described above further degrades, presenting a serious problem.

The present invention has been developed in view of the above problems and an object thereof is to detect defects that are difficult to detect from an optical image with high precision by using an electron beam image and at the same time, to prevent throughput degradation of an inspection apparatus and an inspection method caused during detection as much as possible.

The present invention also provides an inspection apparatus and an inspection method excellent in that high-sensitivity defect detection performance is achieved without causing throughput degradation even if an adequate contrast of a defective region cannot be obtained due to characteristics of a wafer.

To solve the problems, procedures and nature of forward scans and backward (retrace) scans of an electron beam are controlled in the present invention.

That is, a pattern inspection apparatus according to the present invention is an inspection apparatus for detecting defects of a sample and includes a scanning means for causing an electron beam to repeatedly scan the sample reciprocatingly on a line, an image acquisition means for generating an image based on secondary electrons or reflected electrons generated from the sample, a defect detection means for detecting defects from an image generated by the image acquisition means, a control means for controlling a scan with an electron beam by the scanning means, and a setting means for setting scanning conditions for the electron beam controlled by the control means, wherein the setting means has a means for setting an operation by a forward scan of the electron beam to any one of image acquisition, precharging, and discharging. A pattern inspection method according to the present invention is a method by which defective portions are determined from an image generated based on secondary electrons or reflected electrons generated from a sample after causing an electron beam to repeatedly scan the sample reciprocatingly on a line, wherein an image is acquired by a forward scan of the electron beam and an image, precharging, or discharging is acquired by a backward scan of the electron beam. Accordingly, the inspection method can be set to an optimal one depending on nature of the inspected sample so that defects on the surface of the inspected sample can be detected with high precision.

In the pattern inspection apparatus in another aspect of the present invention, the setting means has a means for setting a scanline of a forward scan and that of a backward scan by the electron beam caused to scan by the scanning means. Particularly, the setting means has a means for making settings so that after an L-th (L is a natural number) line being scanned by a forward scan of the electron beam, an (L−M)-th line (M is a natural number smaller than L) is scanned by a backward scan and further, a means for making settings so that after the (L−M)-th line being scanned by the backward scan, an (L+N)-th (N is a natural number) line is scanned by a forward scan. Similarly, in the pattern inspection method of the present invention, when the electron beam is caused to repeatedly scan reciprocatingly on a line, a scanline of the forward scan and that of the backward scan are each controlled. Particularly, after an L-th (L is a natural number) line being scanned by a forward scan of the electron beam, control is exerted so as to scan an (L−M)-th line (M is a natural number smaller than L) by a backward scan and further, after the (L−M)-th line being scanned by the backward scan, control is exerted so as to scan an (L+N)-th (N is a natural number) line by a forward scan. Accordingly, a time interval can be provided between a forward scan and a backward (retrace) scan so that defect detection with higher precision can be achieved by making a defective portion clearer. Moreover, throughput degradation is not caused because the backward scan is used effectively.

In the pattern inspection apparatus in another aspect of the present invention, the setting means has a means for making settings so that after an L-th (L is a natural number) line being scanned by a forward scan of the electron beam, an (L+M)-th line (M is a natural number) is scanned by a backward scan and further, a means for making settings so that after the (L+M)-th line being scanned by the backward scan, an (L−N)-th (N is a natural number smaller than L) line is scanned by a forward scan. Similarly, in the pattern inspection method, after an L-th (L is a natural number) line being scanned by a forward scan of the electron beam, control is exerted so as to scan an (L+M)-th line (M is a natural number) by a backward scan and further, after the (L+M)-th line being scanned by the backward scan, control is exerted so as to scan an (L−N)-th (N is a natural number smaller than L) line by a forward scan. Accordingly, a time interval can be provided between a forward scan and a backward scan so that defect detection with higher precision can be achieved by making a defective portion clearer. Moreover, throughput degradation is not caused because the backward scan is used effectively.

Further, in the pattern inspection apparatus in another aspect of the present invention, the setting means may have a means for setting the number of times of continuously scanning the same line reciprocatingly with the electron beam. Similarly, in the pattern inspection method, when the electron beam is caused to repeatedly scan reciprocatingly on a line, control may be exerted so as to continuously scan the same line reciprocatingly a plurality of times with the electron beam.

Further, in the pattern inspection apparatus of the present invention, the setting means may be a GUI (Graphical User Interface) to which a user can set the scanning method and conditions from outside. Similarly, in the pattern inspection method, instructions concerning the scanning method of an electron beam may be made to be entered through the GUI. Accordingly, the user can easily select the optimal scanning method and conditions depending on characteristics of an inspected sample with excellent visibility and operability.

In the pattern inspection apparatus and pattern inspection method of the present invention, the above retrace scan may be constituted by a forward scan.

### BRIEF DESCRIPTION OF THE DRAWINGS

FIG. 1 is a diagram showing an outline configuration of an SEM pattern inspection apparatus applied to the present invention.

FIG. 2A and FIG. 2B are diagrams showing a scanning operation of an electron beam according to a first embodiment of the present invention.

FIG. 3A and FIG. 3B are diagrams showing the scanning operation of an electron beam according to a second embodiment of the present invention.

FIG. 4A and FIG. 4B are diagrams showing the scanning operation of an electron beam according to a third embodiment of the present invention.

FIG. 5A and FIG. 5B are diagrams showing the scanning operation (spiral scan) of an electron beam according to a fourth embodiment of the present invention.

FIG. 6A and FIG. 6B are diagrams showing the scanning operation (spiral scan) of an electron beam according to a fifth embodiment of the present invention.

FIG. 7A and FIG. 7B are diagrams showing the scanning operation (alternating addition) of an electron beam according to a sixth embodiment of the present invention.

FIG. 8 is a diagram showing an operation screen example of an SEM pattern inspection apparatus 1 of the present invention.

### DETAILED DESCRIPTION OF THE PREFERRED EMBODIMENTS

Embodiments of the present invention will be described in detail with reference to appended drawings. However, these embodiments are only examples for realizing the present invention and the present invention is not limited to these embodiments.

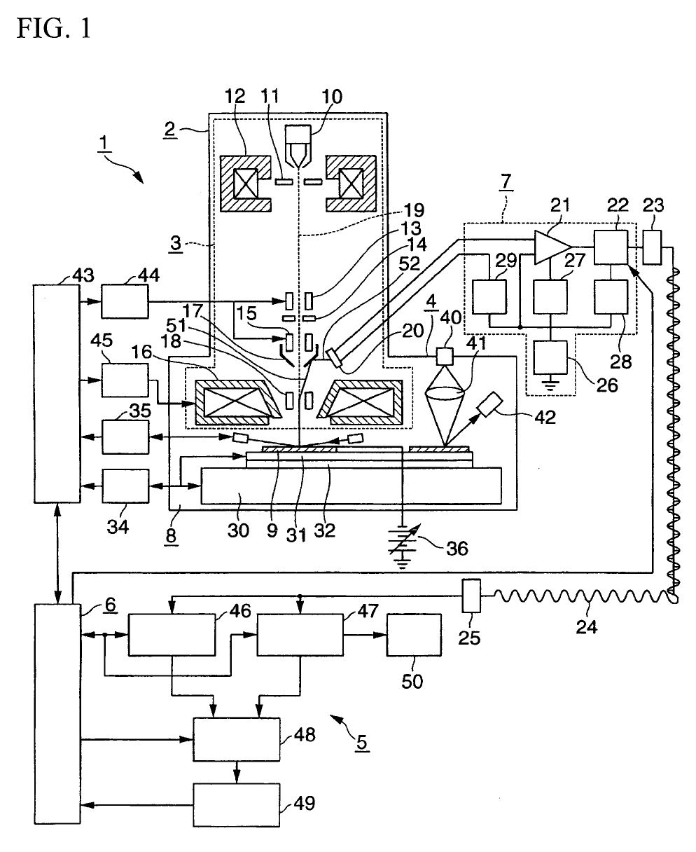

FIG. 1 is a longitudinal sectional view showing the configuration of the SEM pattern inspection apparatus 1, which exemplifies an inspection apparatus using a scanning election microscopy to which the present invention is applied. The SEM pattern inspection apparatus 1 includes an inspection chamber 2 evacuated by a vacuum pump (not shown) and a spare chamber (not shown) for transporting a sample substrate 9 into the inspection chamber 2. The spare chamber is constructed so as to be evacuated independently of the inspection chamber 2. In addition to the inspection chamber 2 and the spare chamber, the SEM pattern inspection apparatus 1 includes an image processor 5, a control part 6, a secondary electron detection part 7, and a correction control circuit part 43.

The inspection chamber 2 principally comprises an electro-optical system 3, a sample chamber 8, and an optical microscope part 4. The electro-optical system 3 includes an electron gun 10, electron beam extractor electrodes 11, condensing lenses 12, a blanking deflector 13, a scanning deflector 15, an aperture 14, objective lenses 16, a beam reflector 17, and an ExB deflector 18. A secondary electron detector 20 of the secondary electron detection part 7 is arranged above the objective lens 16 in the inspection chamber 2. An output signal of the secondary electron detector 20 is amplified by a preamplifier 21 installed outside the inspection chamber 2 and converted into digital data by an AD converter 22.

The sample chamber 8 includes a sample support 30, an X stage 31, a Y stage 32, a length measuring instrument for position monitoring 34, and an inspected sample height measuring instrument 35. The optical microscope part 4 is installed at a position in the vicinity of the electro-optical system 3 in the inspection chamber 2 and separated from each other to such an extent that the electro-optical system 3 and the optical microscope part 4 are not mutually affected, and the distance between the electro-optical system 3 and the optical microscope part 4 is known. Moreover, the X stage 31 or the Y stage 32 can reciprocate across the distance between the electro-optical system 3 and the optical microscope part 4. The optical microscope part 4 includes a light source 40, an optical lens 41, and a CCD camera 42.

The image processor 5 includes a first image storage part 46, a second image storage part 47, an operation part 48, and a defect determination part 49. A captured electron beam image or optical image is displayed in a monitor 50.

Operation instructions and operation conditions of each part are inputted and outputted through the control part 6. The control part 6 has conditions such as an acceleration voltage during electron beam generation, electron beam deflection width, deflection speed, signal capturing timing of a secondary electron detection apparatus, and sample support movement speed inputted thereto in advance so that such conditions can optionally or selectively be set in accordance with purposes. The control part 6 monitors the position or height for shifts from signals of the length measuring instrument for position monitoring 34 and the inspected sample height measuring instrument 35 via the correction control circuit 43 and, depending on monitoring results, generates a correction signal and transmits the correction signal to an objective lens power supply 45 or a scanning signal generator 44 so that an electron beam is always shone on a correct position. While, in the above description, an input means for inputting operation instructions and operation conditions is included in the control part 6, the input means may be provided, as described later, in a portion of the monitor 50.

In order to acquire an image of the inspected sample 9, the inspected sample 9 is irradiated with a finely narrowed electron beam 19 to generate secondary electrons 51, which are detected in synchronization with both scanning with the electron beam 19 and movement of the X stage 31 or the Y stage 32 to obtain an image of the inspected sample 9.

In the SEM pattern inspection apparatus, a fast inspection speed is required. Therefore, scanning at low speed with an electron beam of an electron beam current on the order of pA, multi-scanning, and superimposition of individual images like a normal SEM in a conventional system are not performed. In addition, it is necessary to perform electron beam scanning at high speed once or at most several times so as to avoid multi-scanning, in order to also inhibit insulating material from being charged. Thus, the present embodiment is configured to form an image by performing scanning with a large-current electron beam of, for example, 100 nA, which is about 1000 times or more that in a conventional SEM.

A thermal-field emission electron source of diffusion refilling type is used in the electron gun 10. By using the electron gun 10, when compared with, for example, a conventional tungsten/filament electron source and cold-field emission electron source, a stable electron beam current can be secured. Thus, an electron beam image with less variations in brightness is obtained. Since the electron beam current can be set large by the electron gun 10, a high-speed inspection as described later can be achieved. The electron beam 19 is derived from the electron gun 10 by applying a voltage between the electron gun 10 and the electron beam extractor electrodes 11.

The electron beam 19 is accelerated by applying a negative potential of a high voltage to the electron gun 10. Accordingly, the electron beam 19 travels in the direction of the sample support 30 by energy corresponding to the potential thereof, is converged by the condensing lenses 12, and is further shone on the inspected sample 9 mounted on the X stage 31 or the Y stage 32 on the sample support 30 after finely being narrowed down by the objective lenses 16. The inspected sample 9 is, for example, a semiconductor wafer, chip, liquid crystal, or a substrate with fine circuit patterns such as masks.

The scanning signal generator 44 for generating a scanning signal and a blanking signal is connected to the blanking deflector 13 and when it is necessary to blank the electron beam 19, control can be exerted so that the electron beam does not pass through the aperture 14 by causing the electron beam 19 to deflect by the blanking deflector 13. The objective lens power supply 45 is connected to the objective lenses 16 and an amount of focusing of the electron beam 19 can be adjusted by a signal from the objective lens power supply 45.

A negative voltage can be applied to the inspected sample 9 by a high-voltage power supply 36. By adjusting the voltage of the high-voltage power supply 36, the electron beam 19 can be decelerated to adjust electron beam irradiation energy to the inspected sample 9 to an optimal value without changing the potential of the electron gun 10.

The secondary electrons 51 generated by irradiating the inspected sample 9 with the electron beam 19 are accelerated by the negative voltage applied to the inspected sample 9. The ExB deflector 18 for bending the trajectory of secondary electrons without affecting that of the electron beam 19 by both electric and magnetic fields is arranged above the inspected sample 9 and the accelerated secondary electrons 51 are thereby deflected in a predetermined direction. The amount of deflection can be adjusted by strengths of the electric and magnetic fields applied to the ExB deflector 18. The electric and magnetic fields can be varied in interlock with the negative voltage applied to the inspected sample 9.

The secondary electrons 51 deflected by the ExB deflector 18 collide against the beam reflector 17 under predetermined conditions. The beam reflector 17 has a conic shape and has also a shield pipe function of shielding against the electron beam 19 shone on the inspected sample 9. When the accelerated secondary electrons 51 collide against the beam reflector 17, second secondary electrons 52 having energy of several eV to 50 eV are generated by the beam reflector 17.

The secondary electron detection part 7 includes the secondary electron detector 20 provided in the evacuated inspection chamber 2, and includes the preamplifier 21, the AD converter 22, a light conversion means 23, an optical transmission means 24, an electric conversion means 25, a high-voltage power supply 26, a preamplifier driving power supply 27, an AD converter driving power supply 28, and a reverse bias power supply 29, with all provided outside the inspection chamber 2.

Among components of the secondary electron detection part 7, the secondary electron detector 20 is arranged above the objective lenses 16 in the inspection chamber 2. The secondary electron detector 20, the preamplifier 21, the AD converter 22, the light conversion means 23, the preamplifier driving power supply 27, and the AD converter driving power supply 28 are floated at a positive potential by the high-voltage power supply 26. The second secondary electrons 52 generated by collision of the secondary electron 51 against the beam reflector 17 are guided toward the secondary electron detector 20 by an attractive electric field generated by the positive potential.

The secondary electron detector 20 is constructed so as to detect the second secondary electrons 52 generated by collision of the secondary electrons 51 against the beam reflector 17 in interlock with the timing of scanning with the electron beam 19. An output signal of the secondary electron detector 20 is amplified by the preamplifier 21 installed outside the inspection chamber 2 and converted into digital data by the AD converter 22.

The AD converter 22 is configured so that an analog signal detected by the secondary electron detector 20 is converted into a digital signal immediately after the analog signal being amplified by the preamplifier 21 before being sent to the image processor 5. Since the detected analog signal is digitized to send immediately after being detected in the present configuration, a signal that is faster than a conventional signal and has a higher SN ratio can be obtained.

As a method of scanning the inspected sample 9 mounted on the X stage 31 and the Y stage 32, either a method of scanning the inspected sample 9 two-dimensionally (for example, x and y directions) with the electron beam 19 while the X stage 31 and the Y stage 32 being caused to rest during inspection, or a method of linearly scanning with the electron beam 19 in the x direction while the Y stage 32 (along with the stage 31) being continuously moved in the y direction at a constant speed during inspection (with the stage 31) can be selected.

In the case of the former scanning method, when an instruction command for scanlines of forward scan and backward scan inputted from the control part 6 is sent to the correction control circuit 43, a scanning signal is sent from the scanning signal generator 44 to the scanning deflector 15 based on the instruction command to control deflection voltages Vx and Vy in the x and y directions. Accordingly, deflection amounts in the x/y directions of the electron beam are adjusted so that scanlines (two-dimensional in the x and y directions) of the electron beam scanning on the inspected sample 9 and the scanning speed can be controlled. When a specific and relatively narrow area is inspected, the present method by which an inspection is carried out while the inspected sample 9 being caused to rest is advantageous.

In the case of the latter scanning method, when an instruction command for scanlines inputted from the control part 6 is sent to the correction control circuit 43, a scanning signal is sent from the scanning signal generator 44 to the scanning deflector 15 based on the instruction command to control the deflection voltage Vx in the x direction and a position control signal is sent from the correction control circuit 43 to a position controller (not shown) to control the position of the Y stage 32 based on the signal. Accordingly, scanlines (two-dimensional in the x and y directions) of the electron beam scanning on the inspected sample 9 and the scanning speed can be controlled. When a relatively wide area is inspected, the present method by which the inspected sample 9 is moved continuously at a constant speed for inspection is advantageous.

In the present embodiment, a length measuring instrument by laser interference is used as the length measuring instrument for position monitoring 34 for monitoring the positions of the X stage 31 and the Y stage 32. The positions of the X stage 31 and the Y stage 32 can be monitored in real time and results thereof are transferred to the control part 6. Similarly, data such as revolving speeds of motors of the X stage 31 and the Y stage 32 is transferred from each driver to the control part 6 so that the control part 6 can know the area and position where the electron beam 19 is shone correctly based on the data. Therefore, position shifts of the irradiation position of the electron beam 19 can be corrected in real time by the correction control circuit 43 when necessary. In addition, the area where the electron beam 19 has been shone can be stored for each of the inspected samples 9.

An optical measuring instrument, for example, a laser interference measuring instrument or a reflected light measuring instrument that measures changes on the basis of the position of reflected light is used as the inspected sample height measuring instrument 35, which is configured to be able to measure the height of the inspected sample 9 mounted on the X stage 31 or the Y stage 32 in real time. In the present embodiment, a method is used in which a change in height is calculated from position fluctuations by irradiating the inspected sample 9 with an elongated white light having passed through a slit, through a transparent window and then detecting the position of reflected light by a position detection monitor. Based on measured data of the inspected sample height measuring instrument 35, the focal length of the objective lenses 16 is dynamically corrected so that the electron beam 19 always focused on an inspected area can be shone. It is also possible to measure warping of the inspected sample 9 and its distortion in height in advance before electron beam irradiation and to set, based on data thereof, correction conditions of the objective lenses 16 for each inspected area.

The image processor 5 includes the first image storage part 46, the second image storage part 47, the operation part 48, the defect determination part 49, and the monitor 50. An image signal of the inspected sample 9, which is detected by the secondary electron detector 20 is amplified by the preamplifier 21, digitized by the AD converter 22 before being converted into an optical signal by the light conversion means 23, transmitted by the optical transmission means 24, and converted into an electric signal again by the electric conversion means 25 to be stored in the first image storage part 46 or the second image storage part 47. The operation part 48 performs various kinds of image processing for aligning an image signal stored in the first image storage part 46 with that stored in the second image storage part 47, normalizing signal levels, and removing noise signals, and then performs a comparison operation of both image signals. The defect determination part 49 compares the absolute value of a differential image signal obtained by the comparison operation in the operation part 48 with a predetermined threshold, and if the level of the differential image signal is greater than the predetermined threshold, determines pixels thereof to be a defect candidate and displays the position thereof, the number of defects and the like on the monitor 50.

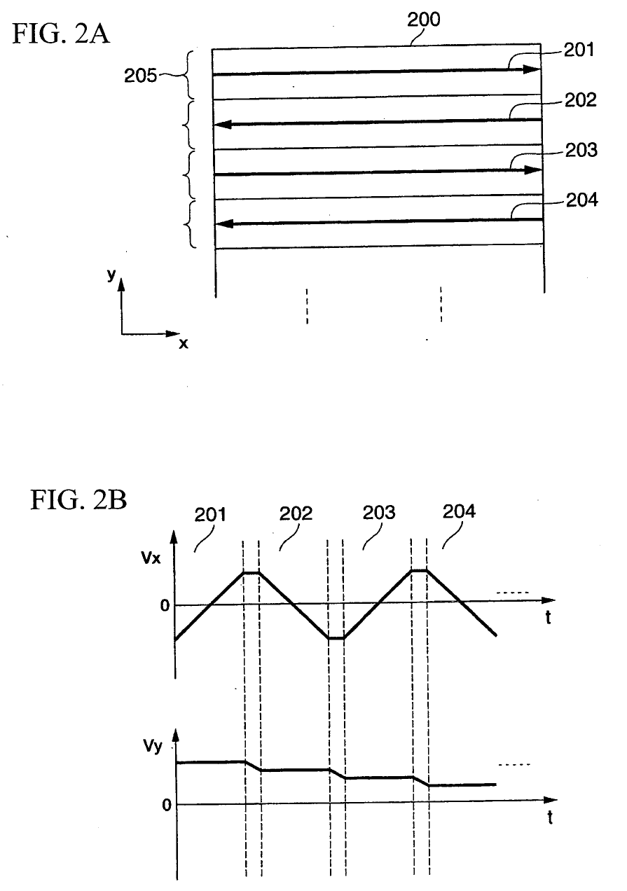

The overall configuration of the SEM pattern inspection apparatus 1 has been described above and the operation of the SEM pattern inspection apparatus 1 of the present invention will be described below. An arrow in a solid line in FIG. 2A and FIG. 2B to FIG. 7A and FIG. 7B to be referenced below denotes an operation in the forward (scanning) direction and an arrow in a broken line denotes an operation in the backward (beam retrace) direction. “Discharge” by electron beam irradiation in embodiments below is to discharge positive charging by irradiation with an electron beam (charge: negative) when the inspected sample is positively charged, and conversely, “precharge” by electron beam irradiation is to make the inspected sample negatively charged or to strengthen negative charging by irradiation with an electron beam (charge: negative) when the inspected sample is not charged or is negatively charged.

### First Embodiment

FIG. 2A and FIG. 2B are diagrams showing the first embodiment regarding the operation of the SEM pattern inspection apparatus 1 of the present invention. FIG. 2A shows how an inspection stripe 200 being scanned for each line pitch 205 in turn from above. FIG. 2B shows deflection voltages Vx and Vy of the scanning deflector 15 during scanning (In this case, it is assumed that the scanning deflector 15 uses an electrostatic deflection system).

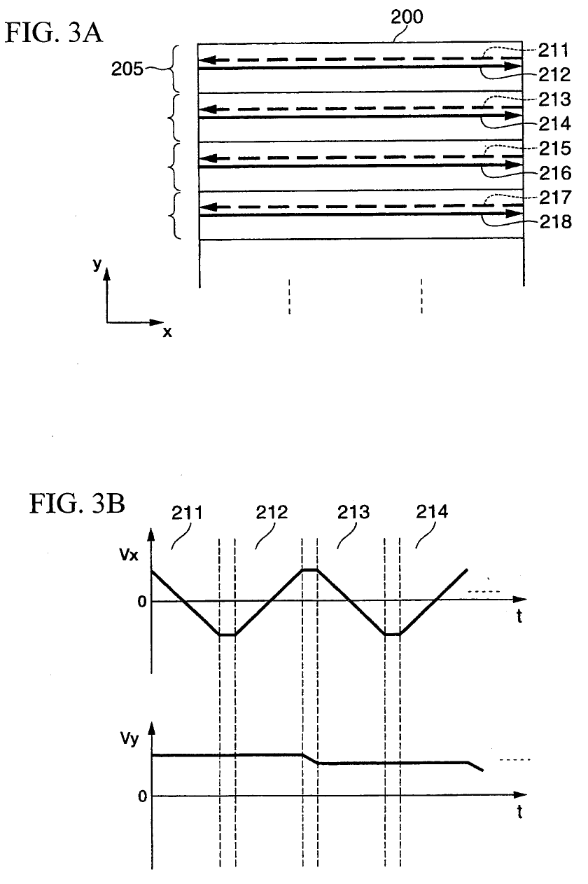

In the present invention, the electron beam 19 can be controlled for scanning in both directions (forward and backward) by the control part 6, the correction control circuit 43, and the scanning signal generator 44. This means that, as shown in FIG. 2B, the scanning deflector 15 is capable of outputting a ramp waveform with high precision, in which the deflection voltage Vx in the principal direction (the x direction in this case) shows an upward slant to the right and a downward slant to the right. Accordingly, as shown in FIG. 2A, scanning signals 201, 202, 203, 204, . . . alternately in both directions can be assigned to the inspection stripe 200 for each line pitch 205. In this case, high-throughput beam scanning with less waste can be achieved as a mode of scanning in an unicursal fashion with a single beam. Although the deflection voltages Vx and Vy in FIG. 2B show changes in deflection voltage in the x and y directions applied to the scanning deflector 15 while the sample stage is immobilized, the sample stage may be moved in the y direction with Vy being kept constant (This also applies to Vy in FIG. 3A and FIG. 3B to FIG. 7A and FIG. 7B). In the present embodiment, while being scanned with the electron beam 19 in the x direction (during a ramp waveform in which Vx shows an upward slant to the right and a downward slant to the right), scanning (movement) in the y direction is not carried (Vy is kept constant), but the present invention is not limited to this. For example, a scan may be performed with the electron beam 19 in the ±x direction while the sample stage being moved in the y direction (This also applies to embodiments described below).

Here, if reference numerals 201 and 203 are defined as a normal scanning direction as forward scans, there is a problem that image data in the retrace direction (backward scans) of reference numerals 202 and 204 is inverse in sequence to that in forward scans. This can be solved by providing a buffer (not shown) before image data being inputted into the image processor 5, rearranging the image data in the order reverse to how the image data was inputted, and reading the image data from the buffer.

According to the method in the present embodiment as described above, by causing the operation as shown in FIG. 2A and FIG. 2B, the inspection time can be shortened compared with a mode in which a scan is performed always in the same direction by retracing after each scan, so that throughput performance can be improved.

While a backward scan is performed after proceeding to the next line in FIG. 2A and FIG. 2B, if addition is needed, high-throughput addition scanning can be achieved by retracing on the same line.

### Second Embodiment

FIG. 3A and FIG. 3B are diagrams showing the second embodiment regarding the operation of the SEM pattern inspection apparatus 1 of the present invention. FIG. 3A and FIG. 3B show an example in which the line 205 is precharged by using a scan from right to left (for example, reference numeral 211) corresponding to a retrace (backward scan) before an inspection scan 212 is performed. The scan 211 and the scan 212 are drawn in FIG. 3A by shifting from each other, but this is intended only to make the figure more legible and does not necessarily apply. That is, scans may actually be performed as if to follow exactly the same place within the line 205 (This also applies to figures below). In contrast to FIG. 2A and FIG. 2B, reference numerals 211, 213, 215, and 217 (broken lines) only shine an electron beam and do not acquire inspection image data.

By adopting the scanning mode described above, there is no need to reverse the order of image data in backward scans as described in the first embodiment and inspection image data can be collected by the same scanning mode (forward scans only) so that improvement in image quality can be expected.

Though precharging may be required to increase the detection ratio of defects depending on the inspection sample or scanning environment, even in such a case, according to the present embodiment, throughput degradation can be minimized.

### Third Embodiment

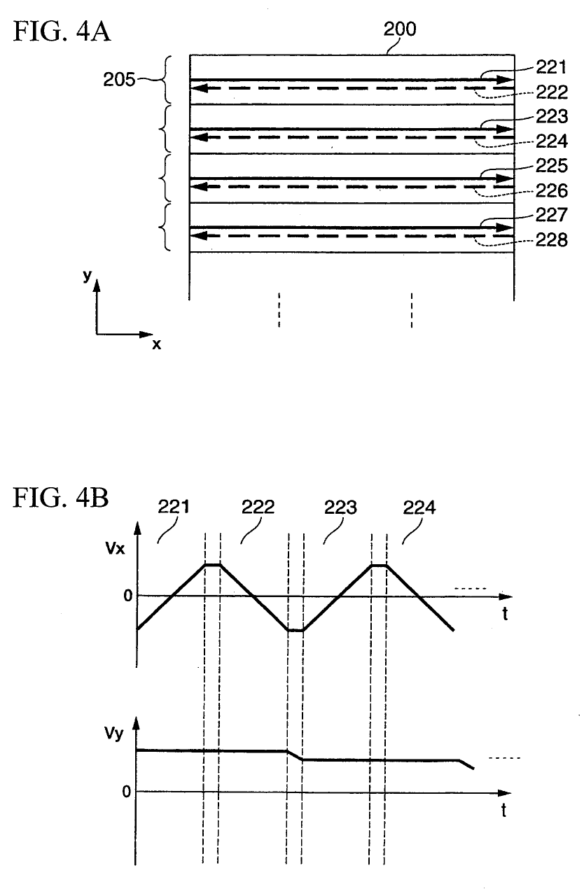

FIG. 4A and FIG. 4B are diagrams showing the third embodiment regarding the operation of the SEM pattern inspection apparatus 1 of the present invention. FIG. 4A and FIG. 4B show, in contrast to FIG. 3A and FIG. 3B, an example in which increased charges applied by an inspection scan are discharged by a retrace scan of reference numeral 222 on the same line 205 (performing a backward scan) after an inspection scan 221.

Like FIG. 3A and FIG. 3B, no inspection image data is acquired in the backward scans and thus, there is no need to reverse the order of data. Depending on the inspection sample or scanning environment, increased charges by an inspection scan may adversely affect defect detection of the next line and even in such a case, according to the present embodiment, discharging can be achieved while throughput degradation being minimized, so that the defect detection ratio can be increased.

### Fourth Embodiment

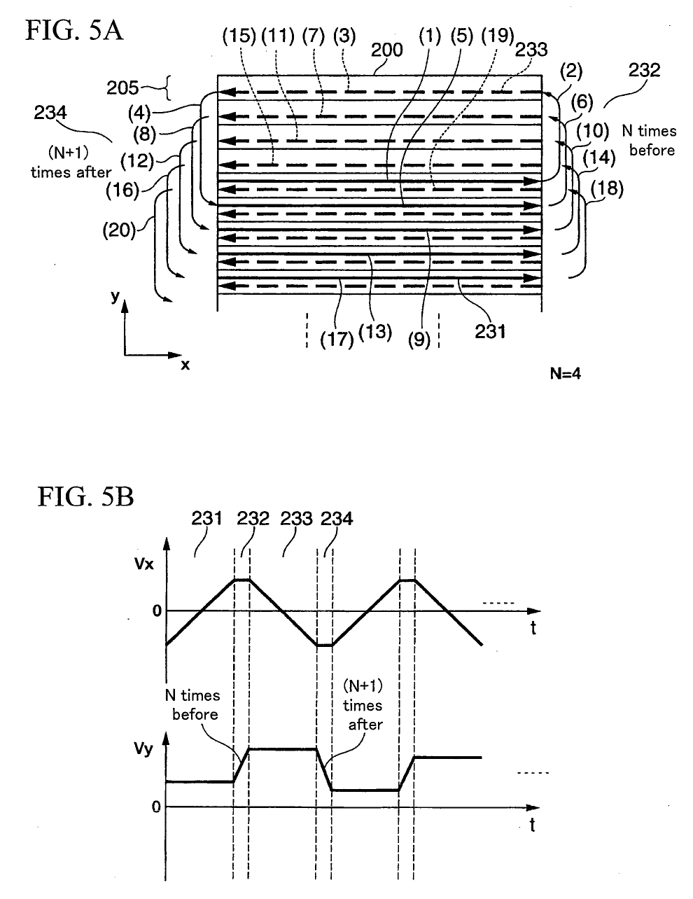

FIG. 5A and FIG. 5B are diagrams showing the fourth embodiment regarding the operation of the SEM pattern inspection apparatus 1 of the present invention. FIG. 5A and FIG. 5B are a modified example of the discharge mode in FIG. 4A and FIG. 4B and a retrace scan (discharging) after a forward scan is performed on a different line from the forward-scanned line. Accordingly, a forward-scanned line can be discharged after a certain interval.

In the present embodiment, scanning is performed in the order of numbers (1), (2), (3) . . . in FIG. 5A. First, after an inspection scan is performed in (1), a retrace scan (backward scan) (3) is performed after going back N times (N is a natural number) (In FIG. 5A, four times before (four lines above)) in (2) and then the next line is inspected by scanning (5) after proceeding (N+1) times (In FIG. 5A, five times after (five lines below)) in (4). Subsequently, the process is repeated in the same way in (6), (7), (8), (9), . . . as if to draw a circle (in a spiral fashion) to continue inspection in the −y direction in FIG. 5A.

In this manner, instead of backward scanning (discharging) the line inspected by scanning immediately after the scan, the line can be discharged after a certain interval. Therefore, depending on the inspection sample or scanning environment, the charging control efficiency can markedly be improved. At the same time, a high-throughput scanning mode with less waste time can be achieved by causing a scan for discharging to perform in the direction opposite to the inspection scan.

The embodiment is simply an example and only discharging of the line inspected by scanning after a certain interval is required. Scanlines of forward scans and backward scans are not limited to these and various kinds of scanline control can be applied. For example, while control is exerted so that forward scans (5), (9), (13), . . . after backward scans (3), (7), (11), . . . are each applied to lines (N+1) times after the backward-scanned line ((N+1) lines below) in FIG. 5A, control may be exerted so that forward scans (5), (9), (13), . . . are each applied to lines (N+M) times after the backward-scanned line ((N+M) lines below (M is a natural number)). This also applies to the fifth embodiment described below.

### Fifth Embodiment

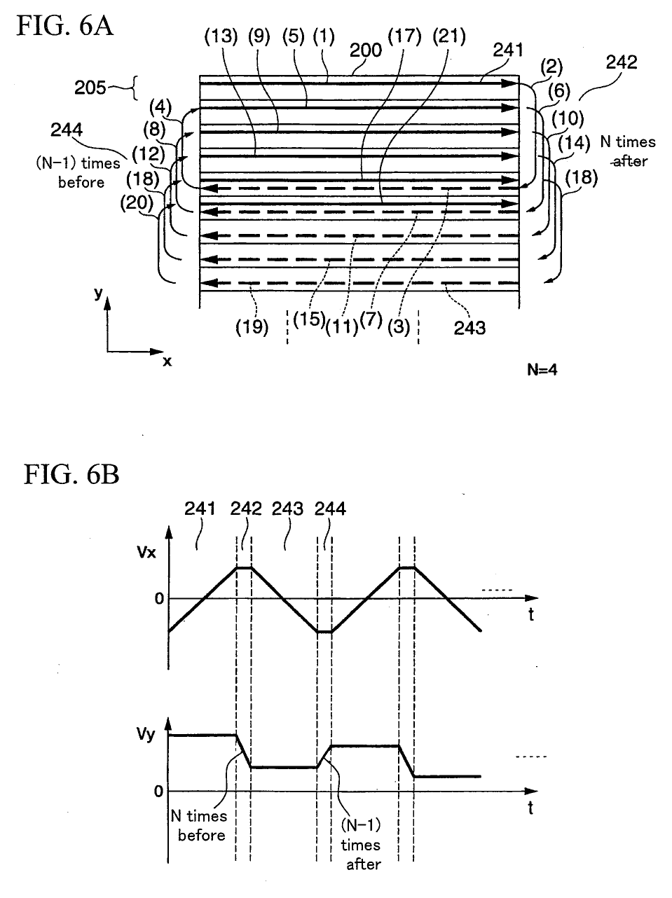

FIG. 6A and FIG. 6B are diagrams showing the fifth embodiment regarding the operation of the SEM pattern inspection apparatus 1 of the present invention. FIG. 6A and FIG. 6B are a modified example of the precharge mode in FIG. 3A and FIG. 3B and a retrace scan (precharging) after a forward scan is performed on a different line from the forward-scanned line. Accordingly, a forward-scanned line can be precharged after a certain interval.

In the present embodiment, scanning is performed in the order of numbers (1), (2), (3), . . . in FIG. 6A. First, after an inspection scan is performed in (1), a retrace scan (3) is performed after proceeding N times (In FIG. 6A, four times after (four lines below)) in (2) and then the next line is inspected by scanning (5) after going back (N−1) times (In FIG. 6A three times before (three lines above)) in (4). Subsequently, the process is repeated in the same way in (6), (7), (8), (9), . . . as if to draw a circle (in a spiral fashion) to continue inspection downward (−y direction).

In this manner, instead of precharging the line inspected by scanning immediately thereafter, the line is precharged after a certain interval and therefore, depending on the inspection sample or scanning environment, the charging control efficiency can markedly be improved. At the same time, a high-throughput scanning mode with less waste time can be achieved by causing a scan for precharging to perform in the direction opposite to the inspection scan.

In the present embodiment, as shown in FIG. 6A, an image is acquired by forward scans (1), (5), (9), and (13) at an edge of an inspected sample, but precharging starts with the backward scan (3) and an acquired image thereof is discarded. That is, an area of the scans (1), (5), (9), and (13) is excluded from an inspection area. However, to eliminate such a waste area, such an area may also be precharged in advance.

Here, performing a scan in a spiral fashion is common to the fourth and fifth embodiments and a difference therebetween lies only in the direction of rotation. The scan proceeds one pitch per rotation in both examples, but these embodiments may be configured so that the scan proceeds m pitches per rotation. If addition is needed, these embodiments may be configured so that the scan proceeds to the next line after drawing the same circle (line) n times. Further, both the fourth and fifth embodiments may be configured so that a retrace scan is constituted by a forward scan.

### Sixth Embodiment

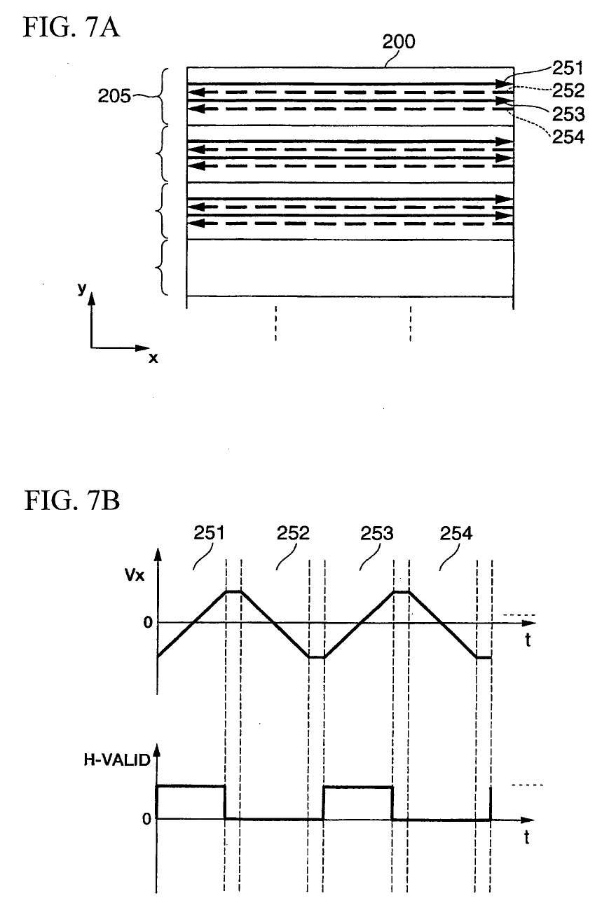

FIG. 7A and FIG. 7B are diagrams showing the sixth embodiment regarding the operation of the SEM pattern inspection apparatus 1 of the present invention. FIG. 7A shows an addition mode in which the same line 205 is repeatedly scanned in both directions. That is, FIG. 7A shows an example in which an image is added four times (an image is acquired four times) by reference numerals 251, 252, 253, and 254 before proceeding to the next line. Accordingly, a high-throughput addition scan can be achieved without causing a dead time by a retrace scan.

Here, if the backward scans 252 and 254 are inspection scans to acquire image data as described above, processing will be complicated because the order of data needs to be reversed. Thus, as shown in FIG. 7B, if a horizontal synchronizing signal (H-valid signal) is turned on only for the forward scans 251 and 253 from which image data is needed, the reversal processing will not be needed. That is, image data will be constituted by the mode of scanning in the same direction so that improvement in quality of inspection images can also be expected. Moreover, the backward scans 252 and 254 may be used for precharging or discharging by which no image is acquired, in accordance with the inspection sample, inspection conditions or the like.

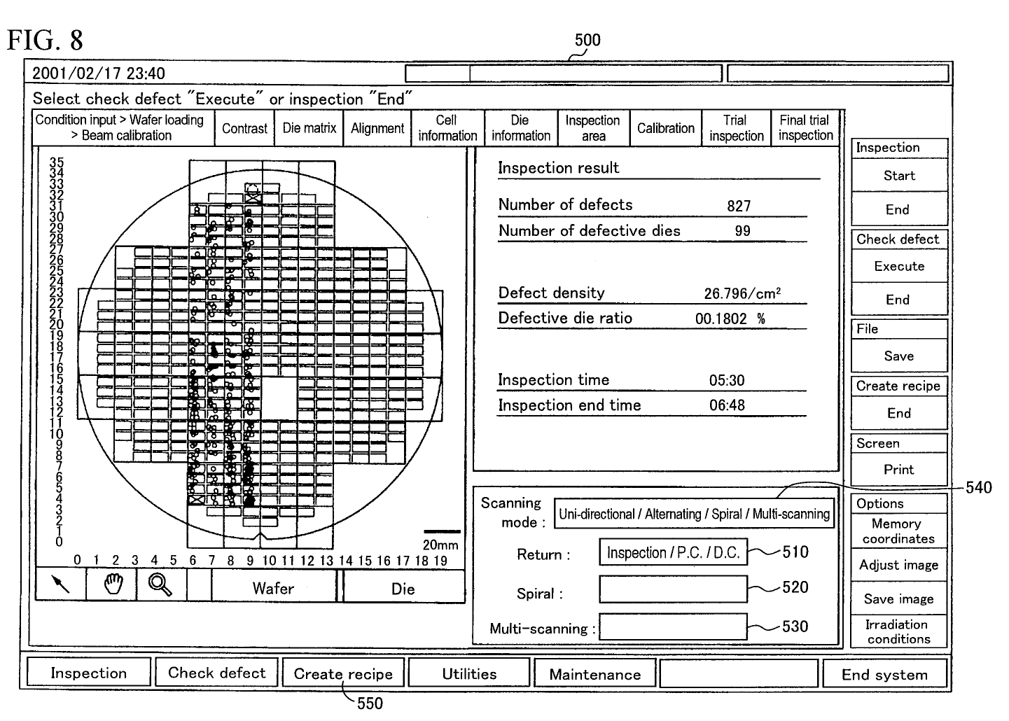

FIG. 8 is a diagram showing an example of an operation screen GUI (Graphical User Interface) of the SEM pattern inspection apparatus 1 of the present invention. FIG. 8 shows an example (an input screen (GUI) in the monitor 50) in which a function selection means for selecting the scanning mode of the present invention is provided in a display means 500 to enable a user to select various conditions with excellent visibility and operability.

Using the GUI, the user selects the scanning mode by means of an input means 540. The selection may be made by using a pull-down menu. Accordingly, the user can select from the mode of scanning only in one direction (unidirectional), the mode of scanning in both directions with a retrace scan being added (alternating), and the spiral mode described in the fourth and fifth embodiment.

Next, detailed functions of each scanning mode are selected by using input means 510, 520, and 530. First, using the input means 510, the role of retrace scan is decided in the scanning mode in which a retrace scan is performed. That is, the user makes a selection of whether to acquire inspection image data by a retrace scan (inspection) or to use a retrace scan for precharging (P. C.) or discharging (D. C.). The input means 520 is used for deciding detailed functions of the spiral mode, for example, the direction of rotation in a spiral fashion, N value, the number of times of addition and the like, as shown in the fourth and fifth embodiment. The input means 530 is used for setting other conditions (such as the number of times of reciprocating scan).

Here, the four input means 540, 510, 520, and 530 are shown, but all these input means need not be provided and input means are not limited to these input means. A method of specifying various conditions by a Create recipe 550 mode is known as a means for including all the above information. In this case, an effect both of saving time and effort to enter each piece of detailed information one by one and of reducing input errors is achieved. Accordingly, inspection conditions can automatically be optimized by entering types of defect, process names and the like, producing an effect of improved usability.

According to the present invention, as described above, defects that are difficult to detect from an optical image can be detected with high precision by using an electron beam image and at the same time, throughput degradation of an inspection apparatus caused during detection can be prevented as much as possible. Further, provided can be an inspection apparatus and an inspection method excellent in that high-sensitivity defect detection performance is achieved without causing throughput degradation even if an adequate contrast of a defective region cannot be obtained due to characteristics of an inspected sample.

### DESCRIPTION OF REFERENCE NUMERALS

1: SEM pattern inspection apparatus
2: inspection chamber
3: electro-optical system
4: optical microscope part
5: image processor
6: control part
7: secondary electron detection part
8: sample chamber
9: inspected sample
10: electron gun
11: electron beam extractor electrodes
12: condensing lenses
13: blanking deflector
14: aperture
15: scanning deflector
16: objective lenses
17: beam reflector
18: ExB deflector
19: electron beam
20: secondary electron detector
21: preamplifier
22: AD converter
23: light conversion means
24: optical transmission means
25: electric conversion means
26: high-voltage power supply
27: preamplifier driving power supply
28: AD converter driving power supply
29: reverse bias power supply
30: sample support
31: X stage
32: Y stage
34: length measuring instrument for position monitoring
35: inspected sample height measuring instrument
36: high-voltage power supply
40: light source
41: optical lens
42: CCD camera
43: correction control circuit part
44: scanning signal generator
45: objective lens power supply
46: first image storage part
47: second image storage part
48: operation part
49: defect determination part
50: monitor
51: secondary electrons
52: second secondary electrons
200: inspection stripe
201, 202, 203, 204: scanning signals
205: line pitch
211: scan
212: inspection scan
221: inspection scan
251 and 253: forward scans
252 and 254: backward scans
500: display means
510, 520, 530 and 540: input means
550: create recipe

What is claimed is:

1. A pattern inspection method of determining defective portions from an image generated based on secondary electrons or reflected electrons generated from a sample after causing an electron beam to repeatedly scan the sample reciprocatingly on a line, comprising the steps of:
acquiring an image by a forward scan of the electron beam; and
acquiring an image, precharging, or discharging by a backward scan of the electron beam.

2. The pattern inspection method according to claim 1, wherein
when the electron beam is caused to repeatedly scan reciprocatingly on a line,
a scanline of the forward scan and that of the backward scan are each controlled.

3. The pattern inspection method according to claim 1, wherein
after an L-th (L is a natural number) line being scanned by a forward scan of the electron beam, control is exerted so as to scan an (L−M)-th line (M is a natural number smaller than L) by a backward scan.

4. The pattern inspection method according to claim 3, wherein
after the (L−M)-th line being scanned by the backward scan, control is exerted so as to scan an (L+N)-th (N is a natural number) line by a forward scan.

5. The pattern inspection method according to claim 1, wherein
after an L-th (L is a natural number) line being scanned by a forward scan of the electron beam, control is exerted so as to scan an (L+M)-th line (M is a natural number) by a backward scan.

6. The pattern inspection method according to claim 5, wherein
after the (L+M)-th line being scanned by the backward scan, control is exerted so as to scan an (L−N)-th (N is a natural number smaller than L) line by a forward scan.

7. The pattern inspection method according to claim 1, wherein
when the electron beam is caused to repeatedly scan reciprocatingly on a line, control is exerted so as to continuously scan the same line reciprocatingly a plurality of times with the electron beam.

8. The pattern inspection method according to claim 3, wherein
a retrace scan of the backward scan is constituted by a forward scan.

9. The pattern inspection method according to claim 1, wherein
instructions concerning a scanning method of the electron beam are inputted through a GUI.

10. A pattern inspection apparatus for detecting defects of a sample, comprising:
a scanning part for causing an electron beam to repeatedly scan the sample reciprocatingly on a line;
an image acquisition part for generating an image based on secondary electrons or reflected electrons generated from the sample;
a defect detection part for detecting defects from an image generated by the image acquisition means;
a control part for controlling a scan with an electron beam by the scanning means; and
a setting part for setting scanning conditions for the electron beam controlled by the control means;
wherein
the setting part has a means for setting an operation by a forward scan of the electron beam to any one of image acquisition, precharging, and discharging.

11. The pattern inspection apparatus according to claim 10, wherein
the setting part has a means for setting a scanline of a forward scan and that of a backward scan by the electron beam caused to scan by the scanning part.

12. The pattern inspection apparatus according to claim 10, wherein
the setting part has a means for making settings so that after an L-th (L is a natural number) line being scanned by a forward scan of the electron beam, an (L−M)-th line (M is a natural number smaller than L) is scanned by a backward scan.

13. The pattern inspection apparatus according to claim 12, wherein
the setting means has a means for making settings so that after the (L−M)-th line being scanned by the backward scan, an (L+N)-th (N is a natural number) line is scanned by a forward scan.

14. The pattern inspection apparatus according to claim 10, wherein
the setting part has a means for making settings so that after an L-th (L is a natural number) line being scanned by a forward scan of the electron beam, an (L+M)-th line (M is a natural number) is scanned by a backward scan.

15. The pattern inspection apparatus according to claim 14, wherein
the setting part has a means for making settings so that after the (L+M)-th line being scanned by the backward scan, an (L−N)-th (N is a natural number smaller than L) line is scanned by a forward scan.

16. The pattern inspection apparatus according to claim 10, wherein
the setting part has a means for setting a number of times of continuously scanning the same line reciprocatingly with the electron beam.

17. The pattern inspection apparatus according to claim 12, wherein
a retrace scan of the backward scan is constituted by a forward scan.

18. The pattern inspection apparatus according to claim 10, wherein
the setting part has a GUI.
